(19) United States
(12) Patent Application Publication
(10) Pub. No.: US 2025/0063477 A1
(43) Pub. Date: Feb. 20, 2025

(54) TECHNIQUES FOR ASSISTED INITIAL ACCESS TO A CELL

(71) Applicant: Lenovo (Singapore) Pte. Ltd., New Tech Park (SG)

(72) Inventor: Hyejung Jung, Northbrook, IL (US)

(21) Appl. No.: 18/805,063

(22) Filed: Aug. 14, 2024

Related U.S. Application Data
(60) Provisional application No. 63/519,803, filed on Aug. 15, 2023.

(51) Int. Cl. H04W 48/14; H04W 48/10; H04W 48/20; H04W 52/02

(52) U.S. Cl. CPC H04W 48/14; H04W 48/10; H04W 48/20; H04W 52/0206

(57) ABSTRACT

Various aspects of the present disclosure relate to receiving, via a first cell, first system information (SI) comprising an indication of a neighboring cell in an energy saving state, and transmitting a request signal to the neighboring cell. Aspects of the present disclosure may relate to receiving, from the neighboring cell, an on-demand system information block (SIB) transmission comprising essential SI for the neighboring cell, where the essential SI comprises a master information block (MIB) for the neighboring cell, or a SIB type 1 (SIB1) for the neighboring cell, or a combination thereof.

### TECHNICAL FIELD

The present disclosure relates to wireless communications, and more specifically to initial access techniques for an energy efficient radio access network (RAN).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include means for receiving, via a first cell, first system information (SI) comprising an indication of a neighboring cell in an energy saving state. The method and apparatuses described herein may include transmitting a request signal to the neighboring cell. The method and apparatuses described herein may include receiving, from the neighboring cell, an on-demand system information block (SIB) transmission comprising essential SI for the neighboring cell, where the essential SI comprises a master information block (MIB) for the neighboring cell, or a SIB type 1 (SIB1) for the neighboring cell, or a combination thereof.

In some implementations, the method and apparatuses described herein may include means for transmitting, via a first cell, first SI comprising an indication of a neighboring cell in an energy saving state. The method and apparatuses described herein may include receiving a request signal via the neighboring cell. The method and apparatuses described herein may include transmitting, via the neighboring cell, an on-demand SIB transmission comprising essential SI for the neighboring cell, wherein the essential SI comprises a MIB for the neighboring cell, or a SIB1 for the neighboring cell, or a combination thereof.

### BRIEF DESCRIPTION OF THE DRAWINGS

FIG. 1 illustrates an example of a wireless communications system in accordance with aspects of the present disclosure.

FIG. 2 illustrates an example of an architecture for initial access techniques for an energy efficient RAN, in accordance with aspects of the present disclosure.

FIG. 3 illustrates an example of a procedure for adaptive cell measurement, when one or more cells are operated in an energy saving manner, in accordance with aspects of the present disclosure.

FIG. 4 illustrates an example of an Abstract Syntax Notation 1 (“ASN.1”) representation of a SIB information element (IE), in accordance with aspects of the present disclosure.

FIG. 5 illustrates an example of an ASN.1 representation of a synchronization signal block (SSB) configuration IE, in accordance with aspects of the present disclosure.

FIG. 6A illustrates an example of a procedure for neighbor cell assisted initial access, when one or more cells are operated in an energy saving manner, in accordance with aspects of the present disclosure.

FIG. 6B is a continuation of the procedure of FIG. 6A.

FIG. 7 illustrates an example of an ASN.1 representation of a SIB IE, in accordance with aspects of the present disclosure.

FIG. 8 illustrates an example of an ASN.1 representation of a configuration IE for requesting system information (SI), in accordance with aspects of the present disclosure.

FIG. 9 illustrates an example of a user equipment (UE) 900, in accordance with aspects of the present disclosure.

FIG. 10 illustrates an example of a processor 1000, in accordance with aspects of the present disclosure.

FIG. 11 illustrates an example of a network equipment (NE) 1100, in accordance with aspects of the present disclosure.

FIG. 12 illustrates a flowchart of a method performed by a RAN entity, in accordance with aspects of the present disclosure.

FIG. 13 illustrates a flowchart of a method performed by a UE, in accordance with aspects of the present disclosure.

FIG. 14 illustrates a flowchart of a method for assisted initial access performed by a UE, in accordance with aspects of the present disclosure.

FIG. 15 illustrates a flowchart of a method for assisted initial access performed by a RAN entity, in accordance with aspects of the present disclosure.

### DETAILED DESCRIPTION

Generally, the present disclosure describes systems, methods, and apparatuses for cell measurement and access to network energy saving (NES) cells. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

In 6^{th} generation (6G) radio access network (RAN), Artificial Intelligence (AI)/Machine Learning (ML) are expected to be widely used in various aspects of network functions and components for efficient network and user equipment (UE) operations. Further, integrated sensing and communication (ISAC), which enables wireless radio sensing and wireless communication by exploiting shared hardware platforms and radio resources, has been identified as one of prominent 6G technology components.

Synchronization signal and broadcast channel (SS/PBCH) transmissions are used for initial access of a radio access network, yet cause significant network energy consumption. Moreover, these SS/PBCH transmissions are wasted energy when no UE is attempting to access the cell. To solve the problems with network energy consumption discussed herein, the present disclosure discloses access and measurement procedures for network energy savings. In various embodiments, these procedures assume integrated sensing and Artificial Intelligence and/or Machine Learning (AI/ML) capabilities in a network entity (NE). According to aspects of a first solution, the network may leverage the integrated sensing to implement sensing-based adaption of SS/PBCH transmissions. Here, the NE of an energy saving cell adaptively transmits synchronization signal (SS) and essential system information (SI) based on sensing reference signal measurement. According to aspects of a second solution, the network may implement adaptive cell measurement for an energy saving cell. Here, a neighboring cell of the energy saving cell sends an indication of active SS measurement configuration to UEs. According to aspects of a third solution, the network may implement a neighbor cell assisted initial access procedure. Here, the neighboring cell of the energy saving cell sends an indication of active random access channel (RACH) occasions for essential SI request resource to UEs.

Aspects of the present disclosure are described in the context of a wireless communications system.

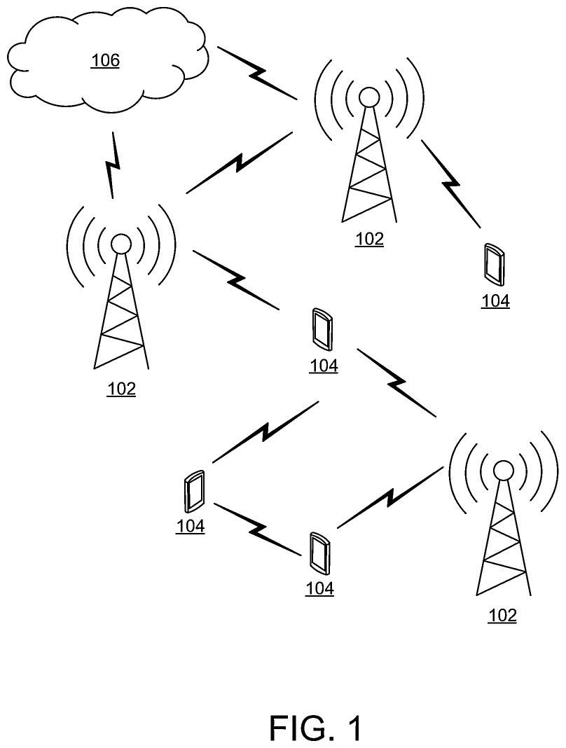

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Wireless communication in unlicensed spectrum (also referred to as “shared spectrum”) in contrast to licensed spectrum offer some obvious cost advantages allowing communication to obviate overlaying operator's licensed spectrum and rather use license free spectrum according to local regulation in specific geographies. From the Third Generation Partnership Project (3GPP) technology perspective, the unlicensed operation can be on the Uu interface (referred to as NR-U) or also on sidelink interface (e.g., SL-U).

For initial access, a UE 104 detects a candidate cell and performs downlink (DL) synchronization. For example, the gNB (e.g., an embodiment of the NE 102) may transmit a synchronization signal and broadcast channel (SS/PBCH) transmission, referred to as a Synchronization Signal Block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode SI based on the SSB. Note that with beam-based communication, each DL beam may be associated with a respective SSB.

After performing DL synchronization and acquiring essential SI, such as the MIB and the SIB1, the UE 104 performs uplink (UL) synchronization and resource request by performing a random access procedure, referred to as “RACH procedure” by selecting and transmitting a preamble on the Physical Random Access Channel (PRACH). The PRACH preamble is transmitted during a RACH occasion, i.e., a predetermined set of time-frequency resources that are available for the reception of the PRACH preamble. Note that with beam-based communication, the UE 104 may select a certain DL beam and transmit the PRACH preamble on a corresponding UL beam. In such embodiments, there may be a mapping between SSB and RACH occasion, allowing the network to determine which beam the UE 104 has selected.

To complete the RACH procedure, after transmitting the PRACH preamble (also referred to as “Msg1”), the UE 104 monitors for a random-access response (RAR) message (also referred to as “Msg2”). The gNB transmits UL timing adjustment information in the RAR and may also schedule an UL resource, referred to as an initial uplink grant.

In 3GPP New Radio (NR), the gNB may transmit the maximum 64 SSBs and the maximum 64 corresponding copies of Physical Downlink Control Channel (PDCCH) and/or Physical Downlink Shared Channel (PDSCH) for delivery of SIB1 in high frequency bands (e.g., 28 GHZ). This may cause significant network energy consumption even for a very low traffic load condition. According to 3GPP Technical Report (TR) 38.864 (v18.1.0), for network energy savings, on-demand SSB and/or SIB1 (SSB/SIB1) transmissions and a cell without SSB/SIB1 transmission were considered. When a cell does not transmit SSB/SIB 1, for a UE to access the cell, the UE should obtain SI of the cell from other associated carriers/cells and synchronize from other associated carriers/cells. When a cell is in a long period of cell inactivity, a UE served by the cell can trigger SSB/SIB1 transmissions by sending a request to the cell.

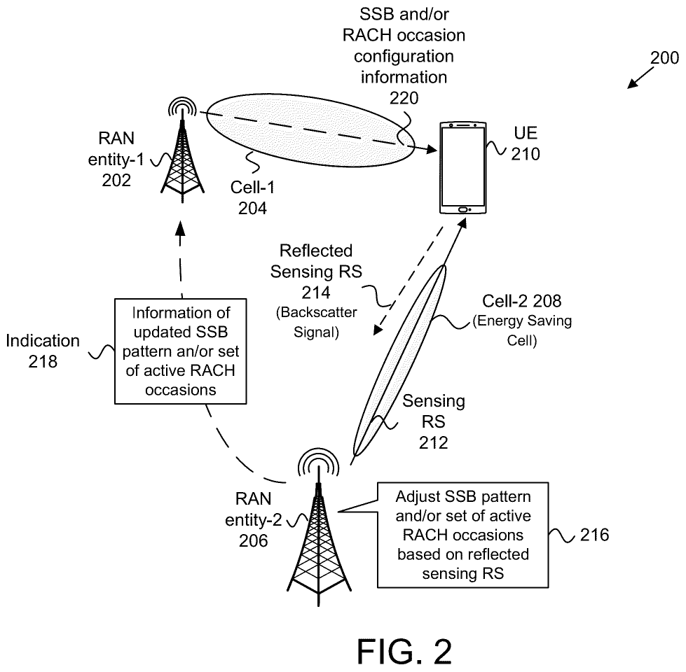

FIG. 2 illustrates an example of an architecture 200 for initial access techniques for an energy efficient RAN, in accordance with aspects of the present disclosure. FIG. 2 shows a first RAN entity 202 (denoted “RAN entity-1”) supporting a first cell 204 (denoted “Cell-1”), a second RAN entity 206 (denoted “RAN entity-2”) supporting an energy saving cell 208 (denoted “Cell-2”), and a UE 210. In various embodiments, the UE 210 is representative of a set of UEs 104 interacting with a set of NEs 102 (e.g., the RAN entities 202, 206).

As depicted, the architecture 200 for initial access techniques for an energy efficient RAN involves the second RAN entity 206 (i.e., corresponding to the energy saving cell 208) transmitting a sending reference signal (RS) 212 and monitoring for a backscatter signal, i.e., the reflected sensing RS 214. The presence of the reflected sensing RS 214 indicates the presence of an object in the coverage area of the energy saving cell 208. The detected object could be a UE, such as the UE 210, or the detected object could be a non-UE object, such as a vehicle (i.e., without UE), a stationary object, etc.

Based at least in part on the reflected sensing RS 214, the second RAN entity 206 may adjust the SSB transmission pattern and/or a set of active RACH occasions corresponding to the energy saving cell 208 (see block 216). For example, upon detecting an object that is likely a UE, the second RAN entity 206 may start transmitting SSB in the energy saving cell 208 or transmit the SSB more frequently, as described in further detail below.

In some embodiments, the second RAN entity 206 may transmit an indication 218 to the first RAN entity 202 (i.e., a neighbor to the energy saving cell 208) to indicate information of an updated SSB transmission pattern and/or an update to the set of RACH occasions. In various embodiments, the first RAN entity 202 transmits, in the first cell 204, SSB configuration information and/or RACH occasion configuration information, e.g., to the UE 210, as described in further detail below (sec signaling 220).

In one embodiment, an NE (e.g., a RAN device) transmits a sensing reference signal and receives the reflected sensing reference signal. The NE performs measurement on the reflected sensing reference signal and potentially detects an object and/or a UE within a targeted coverage area of a first cell. The NE further decides whether to start/stop transmitting synchronization signals (SS) or to decrease/increase SS periodicity (i.e., transmit SS more/less frequently) for a particular spatial direction of the targeted coverage area of the first cell based on the measurement and detection results.

Alternatively, or additionally, the NE decides whether to monitor (or activate) a set of RACH occasions associated with the particular spatial direction of the first cell and whether to transmit essential SI (also referred to as “minimum system information”), such as a MIB and a SIB type 1 (SIB1) and paging downlink control information (DCI)/paging messages in the particular spatial direction, based on the measurement and detection results. Note that the MIB comprises a limited number of most essential parameters that are needed to acquire additional information from the cell. Note that the SIB1 is a cell-specific SIB and comprises information related to cell access. In certain embodiments, the SIB1 includes random access parameters. In certain embodiments, the SIB1 includes information regarding the availability and scheduling of other SIBs. In certain embodiments, SIB1 indicates whether one or more SIBs are only provided on-demand, in which case, it may also provide PRACH configuration needed by the UE to request for the required SI. In certain embodiments, the SIB1 contains radio resource configuration information that is common for all UEs and cell barring information applied to the unified access control.

In an example, the NE indicates an updated SS transmission pattern and/or an updated set of active RACH occasions via dynamic or semi-static signaling in the first cell to inform one or more UEs served by or camping on the first cell. Here, the SS transmission pattern may be defined by an SS periodicity and SS locations within a SS burst (or within a SS transmission window).

In another example, the NE provides the information of the updated SS transmission pattern and/or the updated set of active RACH occasions of the first cell to a second cell. The second cell may be a neighboring cell of the first cell. The second cell indicates the updated SS transmission pattern and/or the updated set of active RACH occasions of the first cell via dynamic or semi-static signaling in the second cell so that one or more UEs currently served by or camping on the second cell can measure the first cell accordingly and change a serving cell to the first cell (e.g. via conditional handover) or perform cell reselection to the first cell, if necessary.

In an implementation, a sensing reference signal is transmitted omni-directionally by a NE, while SS of a cell of the NE is transmitted directionally with beamforming. In a related implementation, a sensing reference signal is transmitted sector-omni directionally, i.e., using widebeam, by the NE, while SS of a cell of the NE is transmitted directionally (i.e., narrowbeam) with beamforming. Once the NE detects potential UE locations, it transmits directional (i.e., beamformed) SS toward the potential UE locations.

In an implementation, a NE activates a set of uplink (UL) resources associated with a particular spatial direction of a first cell (and additionally indicates the set of active UL resources) without transmitting corresponding SS (and MIB/SIB), in response to detecting an object and/or a UE in the particular spatial direction of the first cell. Once the NE detects a UE activity in the set of active UL resources, the NE starts to transmit the corresponding SS (and additionally corresponding MIB/SIB). When the NE detects the object and/or the UE in the spatial direction based on sensing reference signals, it may be difficult for the NE to differentiate the detected object from the UE that can request an access to the first cell.

For example, a detected new lamp post can be either a UE which can communicate with the NE or simply an object. To avoid the NE unnecessarily transmitting SS toward the detected object or not providing necessary SS toward the detected UE, the NE may, at first, monitor the set of active UL resources associated with the spatial direction and transmit SS upon detection of the UE activity on the set of active UL resources. In one example, the NE determines the UE activity by detecting a random access preamble, which may be predefined per PRACH preamble format. In another example, the NE determines the UE activity by measuring received signal power on the set of active UL resources.

In an implementation, a NE transmits an indication that a UE can utilize symbol timing of a first cell to transmit an UL signal (e.g., random access preamble or sounding reference signal (SRS)) in a second cell. If a UE receives an indication in a serving cell, or in a camped cell, that symbol timing of a first cell can be used for transmission in a second cell and a set of UL resources in the second cell is activated and if the UE acquires symbol timing of the first cell, the UE can transmit an UL signal on the activated UL resources without measuring SS of the second cell.

As a network can change a synchronization signal (SS) transmission pattern (e.g., SS periodicity, SS time locations with actual SS transmission within a SS transmission window) dynamically based on sensing and/or other intelligences for network power savings, a duration and/or a periodicity of a SSB measurement window and/or a set of SSB to measure may change frequently, e.g., as frequent as a sensing reference signal periodicity.

In one embodiment, a UE receives a sensing reference signal configuration of a serving cell and/or sensing reference signal configurations of one or more neighbor cells. Further, the UE may receive a plurality of SSB measurement configurations for a serving cell and/or a set of energy saving neighbor cells.

In an implementation, if a UE receives a sensing reference signal configuration of a serving cell and if the UE is scheduled to receive (or transmit) on a resource at least partially overlapping with a resource of the sensing reference signal of the serving cell, the UE performs rate-matching or puncturing on an overlapping resource element(s).

In an implementation, if a UE receives timing information (e.g., periodicity, slot/subframe offset) of sensing reference signal of a neighbor cell, the UE monitors an indication of an updated SSB measurement configuration applicable to the neighbor cell for a configured or predefined duration after an occasion of the sensing reference signal. Upon receiving the indication of the updated SSB measurement configuration, the UE performs cell measurement for the neighbor cell according to the updated SSB measurement configuration. If not receiving (or not detecting) the indication, the UE performs cell measurement for the neighbor cell according to a default SSB measurement configuration. The default SSB measurement configuration is predefined or is configured explicitly or implicitly.

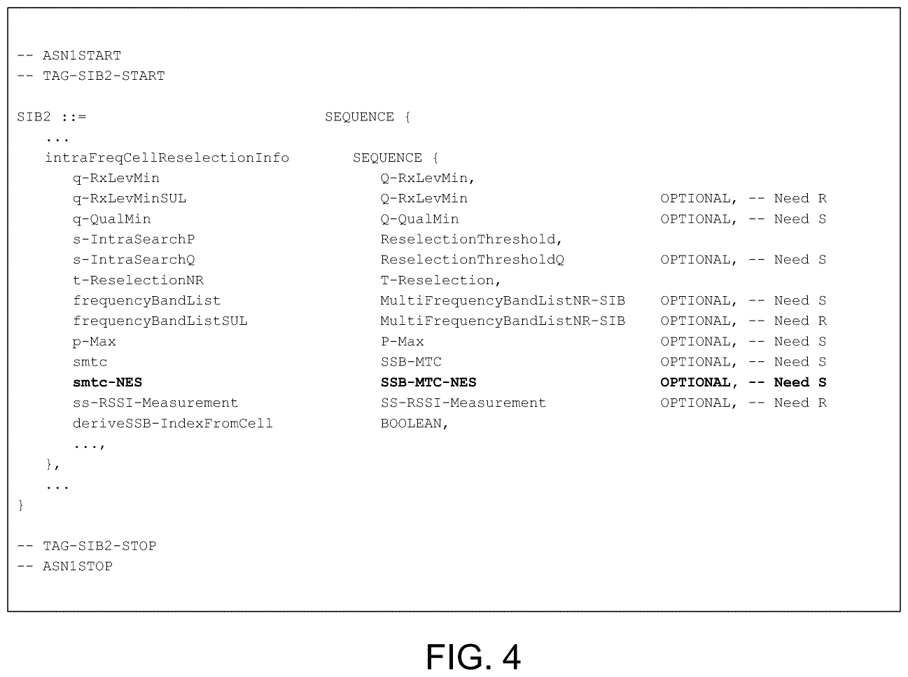

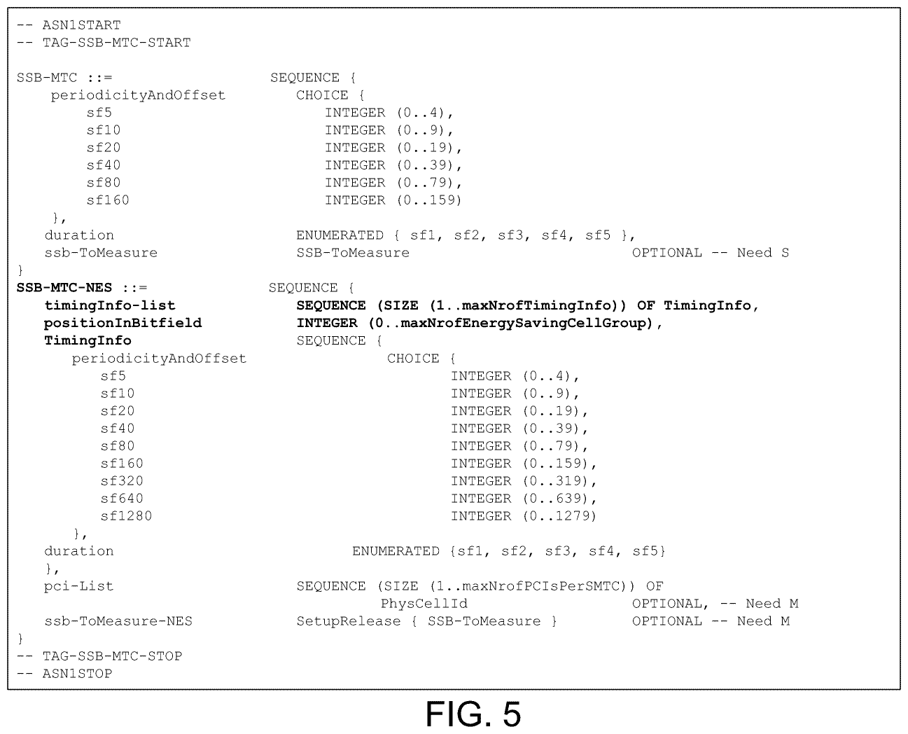

In an example, a set of SSB measurement periodicities and corresponding slot/subframe offset applicable to one or more energy saving cells of an energy saving cell group is configured via SI (e.g., System Information Block type 2 (SIB2)) or dedicated radio resource configuration (RRC) signaling (e.g., as a measurement object), as described below with reference to FIGS. 4 and 5, and Tables 1, 2 and 3. Further, an active SSB measurement periodicity and slot/subframe offset selected from the configured set of SSB measurement periodicities and slot/subframe offset may be indicated via DCI such as paging DCI, DCI associated with SI delivery, or other DCI in common or group-common search space. The DCI may include a bitfield corresponding to indication of a plurality of active SSB measurement configurations, where each of the plurality of active SSB measurement configurations corresponds to each energy saving cell group. The UE may be configured with a starting position of a set of bits indicating an active SSB measurement configuration of a given energy saving cell group within the bitfield.

A network transmits and measures a sensing reference signal, determines an active SS transmission pattern including SS transmission periodicity, and indicates an active SSB measurement configuration corresponding to the active SS transmission pattern.

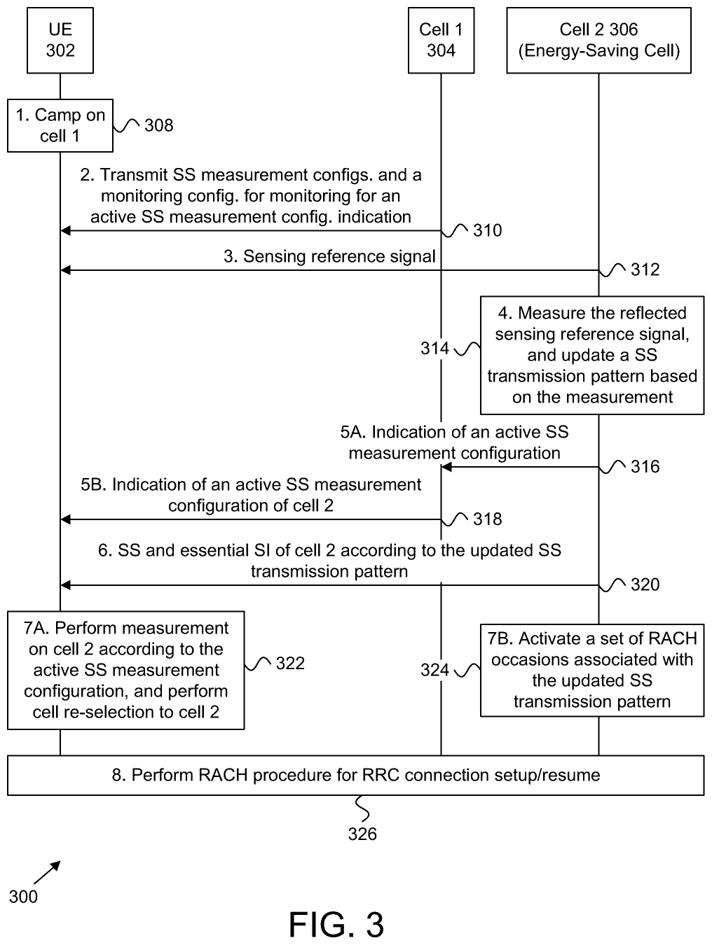

FIG. 3 illustrates an exemplary procedure 300 for adaptive cell measurement, when one or more cells are operated in an energy saving manner, in accordance with aspects of the present disclosure. The procedure 300 involves a UE 302, a RAN comprising a first cell (“cell 1”) 304 (e.g., in a non-energy saving mode of operation), and a second cell (“cell 2”) 306 that operates as an energy saving cell. In certain embodiments, the UE 302 is an embodiment of a UE 104. In certain embodiments, the first and second cells 302-304 are embodiments of a set of gNBs and are representative of a set of NEs 102. In one embodiment, the first and second cells 302-304 belong to the same base station (e.g., same gNB). In another embodiment, the first and second cells 302-304 belong to different base stations (e.g., different gNBs).

The procedure 300 begins at step 1 as the UE 302 camps on the first cell 304 (see block 308). As used herein, “camp on” refers to the UE state in which the UE stays on a cell and is ready to receive an ongoing broadcast (e.g., SS/PBCH) or to initiate a connection for a service. When camping on a cell, the UE is in an idle mode and does not have an active connection (e.g., Radio Resource Control (RRC) connection) with the cell.

At step 2, the first cell 304 transmits a plurality of SS measurement configurations and at least one monitoring configuration (see signaling 310). Here, the monitoring configuration is for the monitoring for an indication of an active SS measurement configuration.

At step 3, the second cell 306 transmits a sensing reference signal (see signaling 312). As mentioned above, the sensing reference signal may be an omnidirectional signal or a sector-omnidirectional signal.

At step 4, the second cell 306 measures the reflected sensing reference signal, and updates a SS transmission pattern based on the measurement (see block 314). Here, it is assumed that the second cell 306 detects the UE 302 based on the reflected sensing reference signal.

At step 5A, the second cell 306 indicates an active SS measurement configuration to the first cell 304 (see signaling 316). In certain embodiments, the second cell 306 sends a backhaul indication to the first cell 304.

At step 5B, the first cell 304 transmits an indication of the active SS measurement configuration associated with the second cell 306 (see signaling 318). In one embodiment, the first cell 304 transmits the indication as a broadcast message. In another embodiment, the first cell 304 transmits the indication as a common DCI. Once the UE 302 is connected (e.g., to the first cell 304), the UE 302 can receive UE-specific DCI indicating an active measurement configuration of the second cell 306.

At step 6, the second cell 306 transmits SS and essential SI of the second cell 306, according to the updated SS transmission pattern (see signaling 320).

At step 7A, the UE 302 performs measurement on the second cell 306 according to the active SS measurement configuration. Based on the cell measurements, the UE 302 performs cell re-selection to the second cell 306 (see block 322).

At step 7B, the second cell 306 activates a set of RACH occasions associated with the update SS transmission pattern (see block 324). As used herein, activating a RACH occasion means that the RAN (e.g., second cell 306) starts to monitor the RACH occasion (i.e., try to detect PRACH preambles on the RACH occasion). In certain embodiments, there is a mapping between an SSB and a corresponding RACH occasion.

At step 8, the UE 302 performs a RACH procedure for RRC connection setup or for RRC connection resume (see block 326). As discussed above, the UE 302 initiates the RACH procedure by transmitting a PRACH preamble during an active RACH occasion.

FIG. 4 depicts an exemplary notation 400 of the SIB2 IE, in accordance with aspects of the present disclosure. The SIB2 IE contains cell re-selection information common for intra-frequency, inter-frequency and/or inter-radio access technology (inter-RAT) cell re-selection (i.e., applicable for more than one type of cell re-selection but not necessarily all) as well as intra-frequency cell re-selection information other than neighboring cell related. To support energy saving cells, the SIB2 IE includes a parameter smtc-NES to indicate a timing configuration for measurements of one or more energy saving cells. The fields of the SIB2 IE are described below in Table 1.

ABLE 1
SIB2 field descriptions

| | |
|---|---|
| deriveSSB-IndexFromCell | This field indicates whether the UE can utilize serving cell timing to derive |
| | the index of SSB transmitted by neighbor cell. If this field is set to true, the |
| | UE assumes System Frame Number (SFN) and frame boundary |
| | alignment across cells on the serving frequency. |
| frequencyBandList | Indicates the list of frequency bands for which the NR cell reselection |
| | parameters apply. |
| intraFreqCellReselectionInfo | Cell re-selection information common for intra-frequency cells. |
| p-Max | Value in dBm applicable for the intra-frequency neighboring NR cells. If |
| | absent the UE applies the specified maximum power. |
| q-QualMin | Parameter “Qqualmin”, applicable for intra-frequency neighbor cells. If the |
| | field is absent, the UE applies the (default) value of negative infinity for |
| | Qqualmin. |
| q-RxLevMin | Parameter “Qrxlevmin” used to indicate minimum reference signal |
| | received power (RSRP) level, applicable for intra-frequency neighbor |
| | cells. |
| q-RxLevMinSUL | Parameter “Qrxlevmin” used to indicate minimum RSRP level for |
| | supplementary uplink (SUL) operation, applicable for intra-frequency |
| | neighbor cells. |
| s-IntraSearchP | Parameter “SintraSearchP”. |
| s-IntraSearchQ | Parameter “SintraSearchQ”. If the field is absent, the UE applies the |
| | (default) value of 0 dB for SintraSearchQ. |
| s-NonIntraSearchP | Parameter “SnonIntraSearchP”. If this field is absent, the UE applies the |
| | (default) value of infinity for SnonIntraSearchP. |
| s-NonIntraSearchQ | Parameter “SnonIntraSearchQ”. If the field is absent, the UE applies the |
| | (default) value of 0 dB for SnonIntraSearchQ. |
| smtc | Measurement timing configuration for intra-frequency measurement. If |
| | this field is absent, the UE assumes that SSB periodicity is 5 ms for the |
| | intra-frequency cells. |
| smtc-NES | Measurement timing configuration for intra-frequency neighbour cells of |
| | energy saving. The pci-List includes the physical cell identities of the |
| | intra-frequency neighbour cells of energy saving. If smtc-NES is absent, |
| | the UE assumes that there are no intra-frequency neighbour cells of |
| | energy saving. |
| t-ReselectionNR | Cell reselection timer value TreselectionNR for NR. The parameter can be |
| | set per NR frequency. |

FIG. 5 depicts an exemplary notation 500 of the SSB-MTC IE, in accordance with aspects of the present disclosure. The SSB-MTC IE is used to configure measurement timing configurations, i.e., timing occasions at which the UE measures SSBs. To support energy saving cells, the SSB-MTC IE includes a parameter SSB-MTC-NES that defines timing information for measurements of a list of one or more energy saving cells. The fields of the parameters SBB-MTC and SSB-MTC-NES are described in Table 2.

TABLE 2
SSB-MTC and SSB-MTC-NES field descriptions

| | |
|---|---|
| duration | Duration of the measurement window in which to receive SS/PBCH blocks. It is |
| | given in number of subframes. |
| periodicityAndOffset | Periodicity and offset of the measurement window in which to receive SS/PBCH |
| | blocks. Periodicity and offset are given in number of subframes. |
| ssb-ToMeasure/ | The set of SSBs to be measured within the SSB-based measurement timing |
| ssb-ToMeasure-NES | configuration (SMTC) measurement duration. When the field is absent the UE |
| | measures on all SSBs. |
| pci-List | Physical Cell Identities (PCIs) that are known to follow this SMTC (SSB-based |
| | radio resource management (RRM) Measurement Timing Configuration). |
| positioninBitField | Starting position of a set of bits indicating an active SSB measurement |
| | configuration of this energy saving cell group within a DCI bitfield corresponding |
| | to indication of active SSB measurement configurations. |

According to aspects of the third solution, to support energy saving cells, the network may use a neighbor cell assisted initial access procedure.

In one embodiment, a UE camping on a first cell receives first SI from the first cell, where the first SI provides information of one or more neighboring cells transmitting their essential system information based on a request (e.g., on-demand SIB1 transmission). The one or more neighboring cells may be in an energy saving state and transmits at least part of essential SI (i.e., SI necessary to access a cell) based upon receiving a request from a UE. The information of the one or more neighboring cells in the first SI of the first cell comprises a cell identity of a neighboring cell and a resource configuration for requesting the essential SI of the neighboring cell.

In one implementation, a neighboring cell in an energy saving state does not transmit a physical broadcast channel (PBCH) carrying a MIB but transmits synchronization signals. The first SI in the first cell may further provide information corresponding to the MIB of the neighboring cell. That is, if a UE camping on the first cell reselects to the neighboring cell (i.e., second cell), the UE retrieves and/or receives a part of essential SI of the second cell from the first cell and receives remaining essential SI of the second cell from the second cell upon requesting the remaining essential SI to the second cell.

In one example, the first SI in the first cell further comprises information of a system frame number (SFN) of the neighboring cell, e.g. an SFN offset with respect to the SFN of the first cell, subcarrier spacing for common channel reception (e.g. SIB1, Msg.2/4 for initial access, paging and SI-messages), a PDCCH configuration for common PDCCH reception (e.g. common control resource set (CORESET) configuration, common PDCCH search space and PDCCH parameters), a frequency offset between synchronization signal and an overall resource block grid in number of subcarriers, and/or Demodulation Reference Signal (DM RS) configuration for downlink and uplink.

In another example, the UE may assume that the SFN of the neighboring cell is same as the SFN of the first cell, and/or a DM RS configuration of a cell of an energy saving state is predefined and is known to the UE.

In another implementation, a neighboring cell (i.e., a second cell) in an energy saving state transmits synchronization signals and corresponding PBCH including a MIB of the neighboring cell. If a UE camping on the first cell reselects to the neighboring cell (second cell), the UE acquires the MIB of the second cell from the second cell and further receives remaining essential SI of the second cell from the second cell upon requesting the remaining essential SI to the second cell.

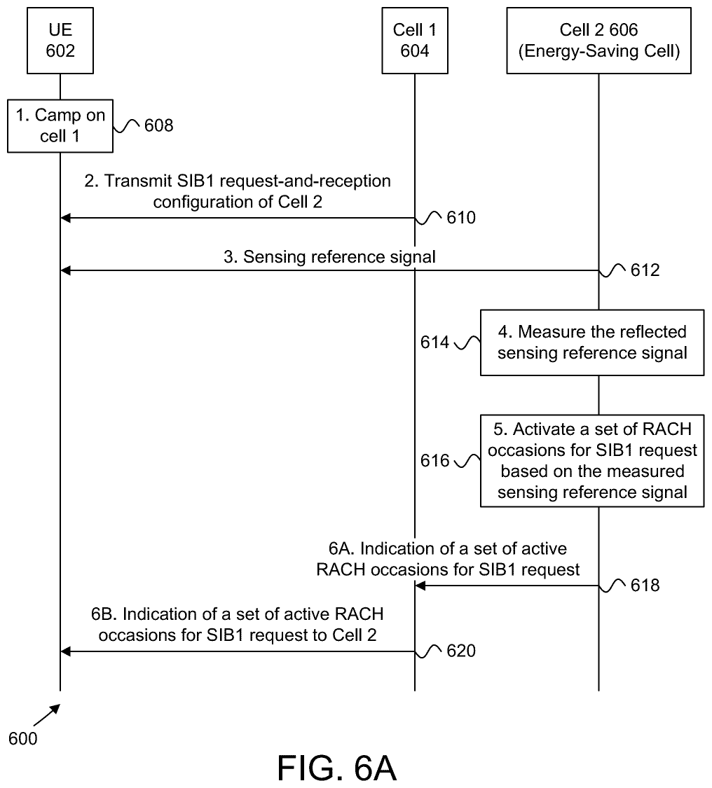

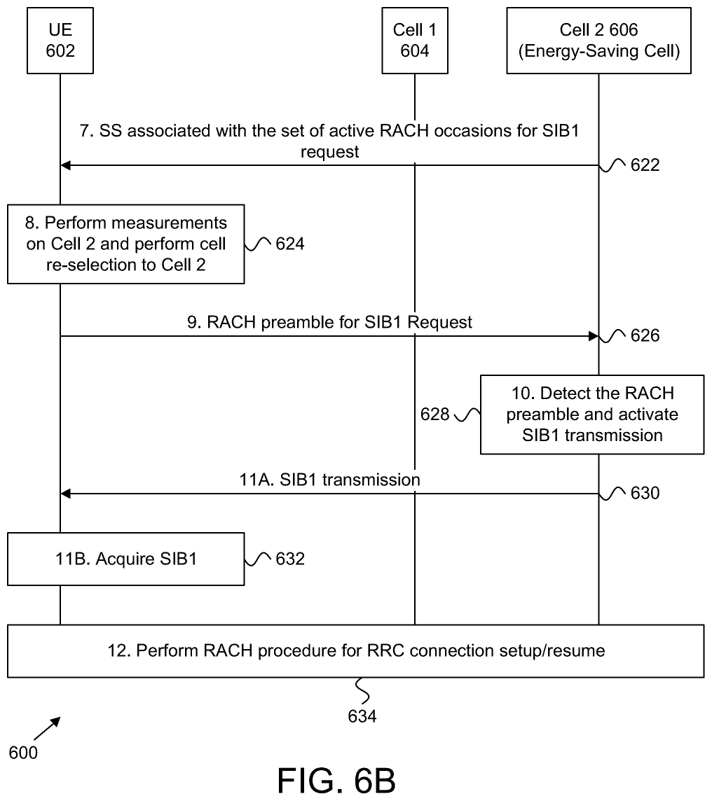

FIGS. 6A-6B illustrate an exemplary neighbor cell assisted initial access procedure 600, when one or more cells are operated in an energy saving manner, in accordance with aspects of the present disclosure. The procedure 600 involves a UE 602, a RAN comprising a first cell (“cell 1”) 604 (e.g., in a non-energy saving mode of operation), and a second cell (“cell 2”) 606 that operates as an energy saving cell. In certain embodiments, the UE 602 is an embodiment of a UE 104. In certain embodiments, the first and second cells 602-604 are embodiments of a set of gNBs and are representative of a set of NEs 102. In one embodiment, the first and second cells 602-604 belong to the same base station (e.g., same gNB). In another embodiment, the first and second cells 602-604 belong to different base stations (e.g., different gNBs).

The procedure 600 begins at step 1 as the UE 602 camps on the first cell 304 (see block 608).

At step 2, the first cell 604 transmits a SIB1 request-and-reception configuration (see signaling 610). Here, the configuration is for the request and reception of SIB1 in the second cell 606.

At step 3, the second cell 606 transmits a sensing reference signal (see signaling 612). As mentioned above, the sensing reference signal may be an omnidirectional signal or a sector-omnidirectional signal.

At step 4, the second cell 606 measures the reflected sensing reference signal (see block 614). Here, it is assumed that the second cell 606 detects the UE 602 based on the reflected sensing reference signal.

At step 5, the second cell 606 activates a set of RACH occasions for the SIB1 request, based on the measured sensing reference signal (see block 616). As used herein, activating a RACH occasion means that the RAN (i.e., second cell 606) starts to monitor the RACH occasion for the transmission of a SIB1 request (e.g., by the UE 602 or another UE in the cell).

At step 6A, the second cell 606 indicates a set of active RACH occasions to the first cell 604 (see signaling 618). In certain embodiments, the second cell 606 sends a backhaul indication to the first cell 604.

At step 6B, the first cell 604 transmits an indication of the set of active RACH occasions associated with the second cell 606 (see signaling 620).

Continuing on FIG. 6B, at step 7, the second cell 606 transmits SS associated with the set of active RACH occasions for the SIB1 request (see signaling 622).

At step 8, the UE 602 performs measurement on the second cell 306 according to the active SS measurement configuration. Based on the cell measurements, the UE 302 performs cell re-selection to the second cell 306 (see block 624).

At step 9, the UE 602 transmits RACH preamble for requesting SIB1 to the second cell 606 (see signaling 626).

At step 10, the second cell 606 detects the RACH preamble for SIB1 and activates SIB transmission (see block 628).

At step 11A, the second cell 606 transmits the SIB1 (see signaling 630).

At step 11B, the UE 602 acquires the SIB1 (see block 632).

At step 12, the UE 602 performs a RACH procedure for RRC connection setup or for RRC connection resume (see block 634). As discussed above, the UE 602 initiates the RACH procedure by transmitting a PRACH preamble (different than the RACH preamble for SIB1) during an active RACH occasion.

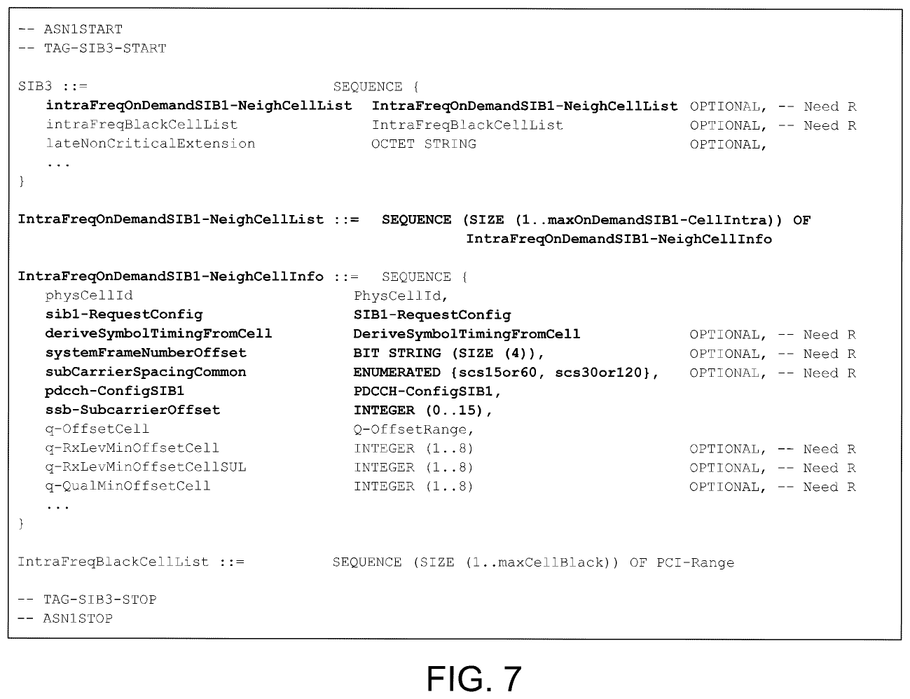

FIG. 7 depicts an exemplary notation 700 of the SIB type 3 (SIB3) IE, in accordance with aspects of the present disclosure. The SIB3 IE provides essential parameters related to cell re-selection, such as thresholds and priorities for intra-frequency, inter-frequency, and inter-RAT (Radio Access Technology) cell re-selection. In some examples, the SIB3 IE contains neighboring cell related information relevant only for intra-frequency cell re-selection. The SIB3 IE includes cells with SIB1 request parameters, as well as blacklisted cells. The fields descriptions of the SIB3 IE are described in Table 3.

TABLE 3
SIB3 field descriptions

| | |
|---|---|
| intraFreqBlackCellList | List of blacklisted intra-frequency neighboring cells. |
| intraFreqOnDemandSIB1- | List of intra-frequency neighboring cells with on-demand SIB1 |
| NeighCellList | transmission. |
| deriveSymbolTimingFromCell | This field indicates whether the UE can utilize serving cell symbol |
| | timing for transmission in a neighbor cell. If this field is set to true, the |
| | UE assumes serving cell symbol timing is same as the neighbor cell |
| | symbol timing. |
| systemFrameNumberOffset | SFN offset of this neighboring cell with respect to the current cell SFN. |
| | If not configured, the SFN is same as SFN of the current cell. |
| subCarrierSpacingCommon | Subcarrier spacing for SIB1, Msg.2/4 for initial access, paging and |
| | broadcast SI-messages in this neighboring cell. If this neighboring cell |
| | is on an FR1 carrier frequency, the value scs 15or60 corresponds to 15 |
| | KHz and the value scs30or120 corresponds to 30 kHz. If this |
| | neighboring cell is on an FR2 carrier frequency, the value scs 15or60 |
| | corresponds to 60 KHz and the value scs30or120 corresponds to 120 |
| | KHz. If not configured, same as the current cell. |
| pdcch-ConfigSIB1 | Determines a common ControlResourceSet (CORESET), a common |
| | search space and necessary PDCCH parameters for this neighboring |
| | cell. |
| ssb-SubcarrierOffset | Frequency offset between synchronization signal and the overall |
| | resource block grid in number of subcarriers in this neighboring cell. |
| q-OffsetCell | Parameter “Qoffsets,n” defined in 3GPP Technical Specification (TS) |
| | 38.304. |
| q-QualMinOffsetCell | Parameter “Qqualminoffsetcell” defined in 3GPP TS 38.304. Actual |
| | value Qqualminoffsetcell = field value [dB]. |
| q-RxLevMinOffsetCell | Parameter “Qrxlevminoffsetcell” defined in 3GPP TS 38.304. Actual |
| | value Qrxlevminoffsetcell = field value * 2 [dB]. |
| q-RxLevMinOffsetCellSUL | Parameter “QrxlevminoffsetcellSUL” defined in TS 38.304. Actual value |
| | QrxlevminoffsetcellSUL = field value * 2 [dB]. |

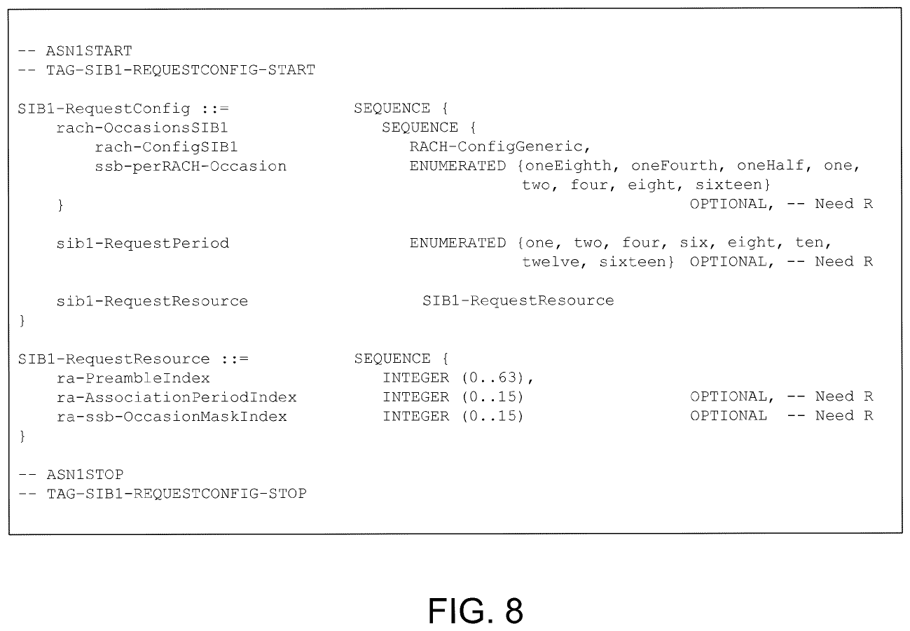

FIG. 8 depicts an exemplary notation 800 of the SIB1-RequestConfig IE, in accordance with aspects of the present disclosure. The SIB1-RequestConfig IE contains configuration for random access preamble based SIB1 request. The fields of parameter SIB1-RequestConfig are described in Table 4. The fields of parameter SIB1-RequestResource are described in Table 5.

TABLE 4
SIB1-RequestConfig field descriptions

| | |
|---|---|
| rach-OccasionsSIB1 | Configuration of RACH Occasions for essential SI (i.e., SIB1). |
| sib1-RequestPeriod | Periodicity of the SIB1-Request configuration in number of association periods. |

TABLE 5
SIB1-RequestResource field descriptions

| | |
|---|---|
| ra-AssociationPeriodIndex | Index of the association period in the sib1-RequestPeriod in which |
| | the UE can send the SIB1 request, using the preambles indicated by |
| | ra-PreambleIndex and RACH occasions indicated by ra-ssb- |
| | OccasionMaskIndex. |
| ra-PreambleIndex | If N SSBs are associated with a RACH occasion, where N > = 1, for |
| | the i-th SSB (i = 0, . . . , N-1) the preamble with preamble index = |
| | ra-PreambleIndex + i is used for SIB1 request; For N < 1, the preamble |
| | with preamble index = ra-PreambleIndex is used for SIB1 request. |

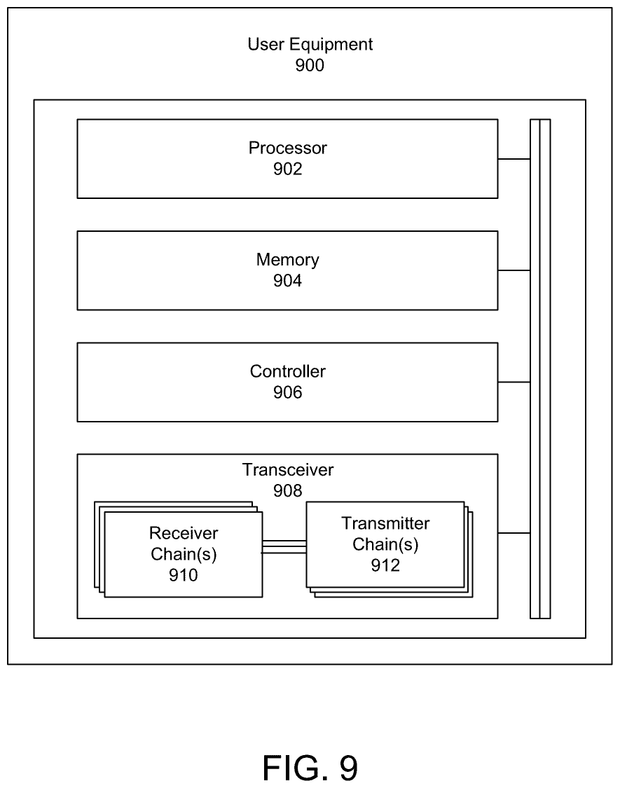

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a central processing unit (CPU), an ASIC, a field programmable gate array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions that, when executed by the processor 902, cause the UE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In various embodiments, the processor 902 and the memory 904 coupled with the processor 902 may be configured to cause the UE 900 to perform one or more of the UE functions described herein (e.g., executing, by the processor 902, instructions stored in the memory 904). Accordingly, the processor 902 may support wireless communication at the UE 900 in accordance with examples as disclosed herein. For example, the UE 900 may be configured to support a means for receiving a plurality of SSB measurement configurations corresponding to a set of (e.g., one or more) energy saving cells.

The UE 900 may be configured to support a means for receiving an indication of an active SSB measurement configuration selected from the plurality of SSB measurement configurations. In some implementations, the indication of the active SSB measurement configuration is received in DCI. The UE 900 may be configured to support a means for performing SSB measurement on the set of energy saving cells according to the active SSB measurement configuration.

In some implementations, the SSB measurement configurations and the indication of an active SSB measurement configuration are received via a first cell. In such implementations, the set of energy saving cells includes a second cell, different than the first cell, and the UE 900 is further configured to perform the SSB measurement on the second cell. In certain implementations, the UE 900 is configured to receive an indication that symbol timing of the first cell can be used for symbol timing of the second cell.

In certain implementations, the UE 900 may be configured to receive, via the first cell, a part of essential SI of the second cell. In such implementations, the UE 900 may be further configured to transmit a random access preamble (i.e., RACH preamble) on a RACH occasion of the second cell and to receive, via the second cell, a remaining essential SI of the second cell in response to transmitting the random access preamble.

In some implementations, the UE 900 may be configured to receive a sensing reference signal configuration corresponding to the set of energy saving cells. In such implementations, to receive the indication, the UE 900 may be configured to monitor the indication during a predefined or configured duration after an occasion of the sensing reference signal.

For assisted initial access to energy saving cells, the UE 900 may be configured to support a means for receiving, via a first cell, first SI including an indication of a neighboring cell in an energy saving state. In some implementations, the first SI includes a cell identity of the neighboring cell. In some implementations, the first SI includes a resource configuration for requesting the essential SI.

The UE 900 may be configured to support a means for transmitting a request signal via the neighboring cell. The UE 900 may be configured to support a means for receiving an on-demand SIB transmission via the neighboring cell, for example, in response to the request signal, where the on-demand SIB transmission includes essential SI for the neighboring cell. In such implementations, the essential SI may include a MIB for the neighboring cell, or a SIB1 for the neighboring cell, or a combination thereof.

In some implementations, the UE 900 may be configured to receive a broadcast from the neighboring cell, where the broadcast includes one or more synchronization signals. In certain implementations, the broadcast includes the MIB for the neighboring cell, and the on-demand SIB lacks the MIB for the neighboring cell. In other implementations, the first SI includes the MIB for the neighboring cell, the broadcast lacks the MIB for the neighboring cell, and the on-demand SIB lacks the MIB for the neighboring cell.

In some implementations, the first SI indicates a set of parameters for the neighboring cell, the set of parameters including one or more of: i) a SFN of the neighboring cell; ii) an SFN offset with respect to a respective SFN of the first cell; iii) a subcarrier spacing for a common channel of the neighboring cell; iv) a PDCCH configuration for a common PDCCH of the neighboring cell; v) a frequency offset between a synchronization signal of the neighboring cell and an overall resource block grid of the neighboring cell; vi) a DM RS configuration for the neighboring cell; or a combination thereof. In some implementations, the UE 900 may be configured to determine an SFN of the neighboring cell based at least in part on a respective SFN of the first cell.

In some implementations, the UE may be configured to: a) receive, from the neighboring cell, a broadcast including one or more synchronization signals; b) reselect from the first cell to the neighboring cell based at least in part on the broadcast; and c) transmit the request signal in response to reselecting to the neighboring cell. In certain implementations, the broadcast includes a first portion of the essential SI (e.g., the MIB), and the on-demand SIB includes a remainder of the essential SI (e.g., the SIB1).

The controller 906 may manage input and output signals for the UE 900. The controller 906 may also manage peripherals not integrated into the UE 900. In some implementations, the controller 906 may utilize an operating system (OS) such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

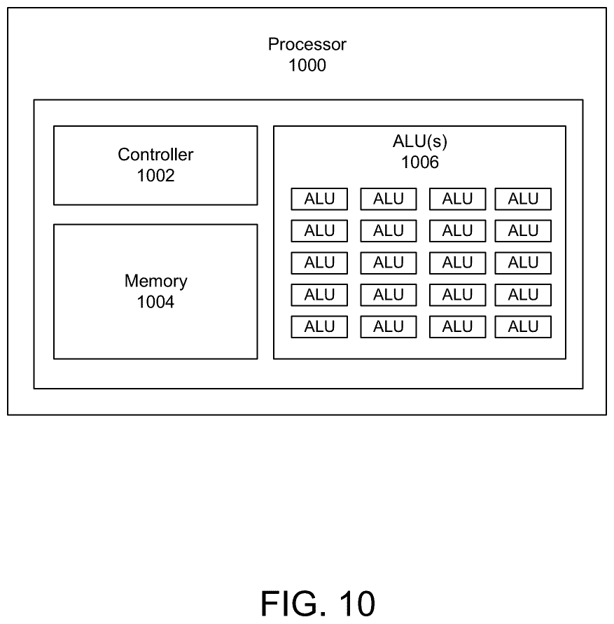

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

In various embodiments, the processor 1000 may support wireless communication of a UE, in accordance with examples as disclosed herein. For example, the processor 1000 may be configured to support a means for receiving a plurality of SSB measurement configurations corresponding to a set of (e.g., one or more) energy saving cells.

The processor 1000 may be configured to support a means for receiving an indication of an active SSB measurement configuration selected from the plurality of SSB measurement configurations. In some implementations, the indication of the active SSB measurement configuration is received in DCI. The processor 1000 may be configured to support a means for performing SSB measurement on the set of energy saving cells according to the active SSB measurement configuration.

In some implementations, the SSB measurement configurations and the indication of an active SSB measurement configuration are received via a first cell. In such implementations, the set of energy saving cells includes a second cell, different than the first cell, and the processor 1000 is further configured to perform the SSB measurement on the second cell. In certain implementations, the processor 1000 is configured to receive an indication that symbol timing of the first cell can be used for symbol timing of the second cell.

In certain implementations, the processor 1000 may be configured to receive, via the first cell, a part of essential SI of the second cell. In such implementations, the processor 1000 may be further configured to transmit a random access preamble (i.e., RACH preamble) on a RACH occasion of the second cell and to receive, via the second cell, a remaining essential SI of the second cell in response to transmitting the random access preamble.

In some implementations, the processor 1000 may be configured to receive a sensing reference signal configuration corresponding to the set of energy saving cells. In such implementations, to receive the indication, the processor 1000 may be configured to monitor the indication during a predefined or configured duration after an occasion of the sensing reference signal.

For assisted initial access to energy saving cells, the processor 1000 may be configured to support a means for receiving, via a first cell, first SI including an indication of a neighboring cell in an energy saving state. In some implementations, the first SI includes a cell identity of the neighboring cell. In some implementations, the first SI includes a resource configuration for requesting the essential SI.

The processor 1000 may be configured to support a means for transmitting a request signal via the neighboring cell. The processor 1000 may be configured to support a means for receiving an on-demand SIB transmission via the neighboring cell, e.g., in response to the request signal, where the on-demand SIB transmission includes essential SI for the neighboring cell. In such implementations, the essential SI may include a MIB for the neighboring cell, or a SIB1 for the neighboring cell, or a combination thereof.

In some implementations, the processor 1000 may be further configured to receive, from the neighboring cell, a broadcast including one or more synchronization signals. In certain implementations, the broadcast includes the MIB for the neighboring cell, and the on-demand SIB lacks the MIB for the neighboring cell. In other implementations, the first SI includes the MIB for the neighboring cell, the broadcast lacks the MIB for the neighboring cell, and the on-demand SIB lacks the MIB for the neighboring cell.

In some implementations, the first SI indicates a set of parameters for the neighboring cell, the set of parameters including one or more of: i) a SFN of the neighboring cell; ii) an SFN offset with respect to a respective SFN of the first cell; iii) a subcarrier spacing for a common channel of the neighboring cell; iv) a PDCCH configuration for a common PDCCH of the neighboring cell; v) a frequency offset between a synchronization signal of the neighboring cell and an overall resource block grid of the neighboring cell; vi) a DM RS configuration for the neighboring cell; or a combination thereof. In some implementations, the processor 1000 may be further configured to determine an SFN of the neighboring cell based at least in part on a respective SFN of the first cell.

In some implementations, the processor 1000 may be further configured to: a) receive, from the neighboring cell, a broadcast including one or more synchronization signals; b) reselect from the first cell to the neighboring cell based at least in part on the broadcast; and c) transmit the request signal in response to reselecting to the neighboring cell. In certain implementations, the broadcast includes a first portion of the essential SI (e.g., the MIB), and the on-demand SIB includes a remainder of the essential SI (e.g., the SIB1).

In various implementations, the processor 1000 may support wireless communication of a RAN entity, such as a base station, in accordance with examples as disclosed herein. For example, the processor 1000 may be configured to support a means for transmitting a set of (e.g., one or more) sensing signals on a first set of resources and performing measurements on the first set of resources. In certain implementations, the set of sensing signals includes a first sensing signal transmitted omni-directionally on a single resource.

The processor 1000 may be configured to support a means for determining a set of (e.g., one or more) active RACH occasions based at least in part on the measurements on the first set of resources. The processor 1000 may be configured to support a means for indicating the set of active RACH occasions and monitoring the set of active RACH occasions. In some implementations, to indicate the set of active RACH, the processor 1000 may be configured to transmit a backhaul indication from the energy saving cell to the active cell, where the active cell transmits the indication to the UE.

In some implementations, the processor 1000 may be configured to select a second set of resources based at least in part on the measurements on the first set of resources and to transmit a set of (e.g., one or more) synchronization signals on the second set of resources. In certain implementations, the set of synchronization signals are associated with the set of active RACH occasions. In certain implementations, the set of active RACH occasions is monitored in response to transmitting the set of synchronization signals.

In certain implementations, when selecting the second set of resources, the processor 1000 may update a transmission pattern of the set of synchronization signals based on the based at least in part on the measurements on the first set of resources. In such implementations, the processor 1000 transmits the set of synchronization signals according to the updated transmission pattern.

In some implementations, when indicating the set of active RACH occasions, the processor 1000 is configured to indicate the transmission pattern of the set of synchronization signals, where the transmission pattern of the set of synchronization signals includes an implicit indication of the set of active RACH occasions. For example, an SSB measurement configuration (e.g., measurement window duration) may be dependent on an SSB transmission pattern.

In some implementations, the processor 1000 may be configured to support a means for detecting a random access preamble on a respective RACH occasion of the set of active RACH occasions and transmitting a set of synchronization signals on a second set of resources in response to detecting the random access preamble. In some implementations, the processor 1000 may be configured to support a means for indicating an active measurement timing configuration based at least in part on the measurements on the first set of resources.

In some implementations, the set of sensing signals is transmitted in a first cell and the set of active RACH occasions is a set of active RACH occasions of the first cell. In such implementations, the processor 1000 may be configured to support a means for transmitting, in a second cell, an indication of the set of active RACH occasions of the first cell. In certain implementations, the processor 1000 may be configured to support a means for transmitting an indication that symbol timing of the second cell can be used for symbol timing of the first cell.

In certain implementations, the processor 1000 may be configured to support a means for transmitting, in the second cell, a part of essential SI of the first cell. In such implementations, the processor 1000 may be configured to support a means for transmitting, in the first cell, a remaining essential SI of the first cell, upon detecting a random access preamble on a RACH occasion of the set of active RACH occasions of the first cell.

For assisted initial access to energy saving cells, the processor 1000 may be configured to support a means for transmitting, via a first cell, first SI including an indication of a neighboring cell in an energy saving state. In some implementations, the first SI includes a cell identity of the neighboring cell. In some implementations, the first SI includes a resource configuration for requesting the essential SI.

The processor 1000 may be configured to support a means for receiving a request signal via the neighboring cell. The processor 1000 may be configured to support a means for transmitting an on-demand SIB transmission via the neighboring cell, e.g., in response to the request signal, where the on-demand SIB transmission includes essential SI for the neighboring cell. In such implementations, the essential SI may include a MIB for the neighboring cell, or a SIB1 for the neighboring cell, or a combination thereof.

In some implementations, the processor 1000 may be further configured to transmit, via the neighboring cell, a broadcast including one or more synchronization signals. In certain implementations, the broadcast includes a first portion of the essential SI (e.g., the MIB) for the neighboring cell, and the on-demand SIB lacks the first portion of the essential SI (e.g., the MIB) for the neighboring cell. In other implementations, the first SI includes the first portion of the essential SI (e.g., the MIB) for the neighboring cell, the broadcast lacks the first portion of the essential SI (e.g., the MIB) for the neighboring cell, and the on-demand SIB lacks the first portion of the essential SI (e.g., the MIB) for the neighboring cell and includes a remainder of the essential SI (e.g., the SIB1).

In some implementations, the first SI indicates a set of parameters for the neighboring cell, the set of parameters including one or more of: i) a SFN of the neighboring cell; ii) an SFN offset with respect to a respective SFN of the first cell; iii) a subcarrier spacing for a common channel of the neighboring cell; iv) a PDCCH configuration for a common PDCCH of the neighboring cell; v) a frequency offset between a synchronization signal of the neighboring cell and an overall resource block grid of the neighboring cell; vi) a DM RS configuration for the neighboring cell; or a combination thereof. In certain implementations, the SFN of the neighboring cell may be based at least in part on a respective SFN of the first cell.

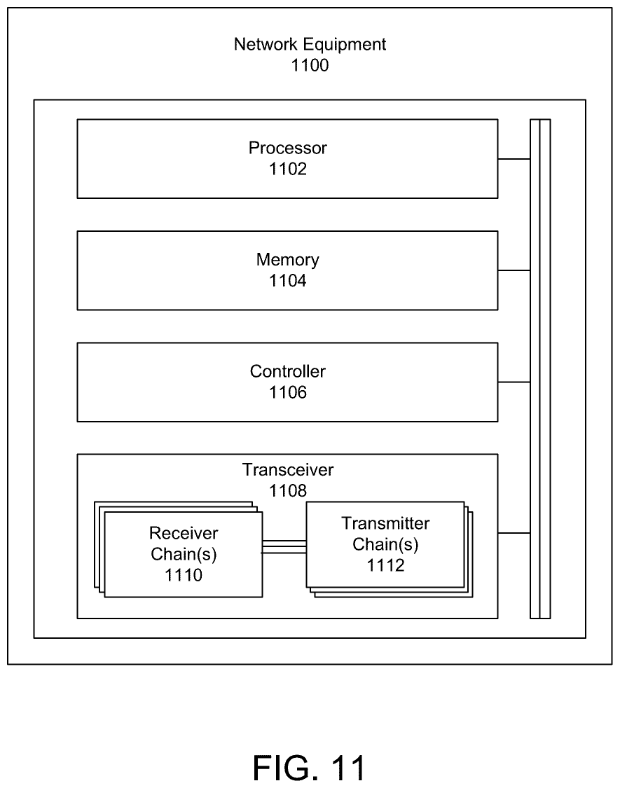

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In various embodiments, the processor 1102 and the memory 1104 coupled with the processor 1102 may be configured to cause the NE 1100 to perform one or more of the RAN functions described herein (e.g., executing, by the processor 1102, instructions stored in the memory 1104). For example, the processor 1102 may support wireless communication at the NE 1100 in accordance with examples as disclosed herein.

The NE 1100 may be configured to support a means for transmitting a set of (e.g., one or more) sensing signals on a first set of resources and performing measurements on the first set of resources. In certain implementations, the set of sensing signals includes a first sensing signal transmitted omni-directionally on a single resource.

The NE 1100 may be configured to support a means for determining a set of (e.g., one or more) active RACH occasions based at least in part on the measurements on the first set of resources. The NE 1100 may be configured to support a means for indicating the set of active RACH occasions and monitoring the set of active RACH occasions. In some implementations, to indicate the set of active RACH, the NE 1100 may be configured to transmit a backhaul indication from the energy saving cell to the active cell, where the active cell transmits the indication to the UE.

In some implementations, the NE 1100 may be configured to select a second set of resources based at least in part on the measurements on the first set of resources and to transmit a set of (e.g., one or more) synchronization signals on the second set of resources. In certain implementations, the set of synchronization signals are associated with the set of active RACH occasions. In certain implementations, the set of active RACH occasions is monitored in response to transmitting the set of synchronization signals.

In certain implementations, when selecting the second set of resources, the NE 1100 may update a transmission pattern of the set of synchronization signals based on the based at least in part on the measurements on the first set of resources. In such implementations, the NE 1100 transmits the set of synchronization signals according to the updated transmission pattern.

In some implementations, when indicating the set of active RACH occasions, the NE 1100 is configured to indicate the transmission pattern of the set of synchronization signals, where the transmission pattern of the set of synchronization signals includes an implicit indication of the set of active RACH occasions. For example, an SSB measurement configuration (e.g., measurement window duration) may be dependent on an SSB transmission pattern.

In some implementations, the NE 1100 may be configured to support a means for detecting a random access preamble on a respective RACH occasion of the set of active RACH occasions and transmitting a set of synchronization signals on a second set of resources in response to detecting the random access preamble. In some implementations, the NE 1100 may be configured to support a means for indicating an active measurement timing configuration based at least in part on the measurements on the first set of resources.

In some implementations, the set of sensing signals is transmitted in a first cell and the set of active RACH occasions is a set of active RACH occasions of the first cell. In such implementations, the NE 1100 may be configured to support a means for transmitting, in a second cell, an indication of the set of active RACH occasions of the first cell. In certain implementations, the NE 1100 may be configured to support a means for transmitting an indication that symbol timing of the second cell can be used for symbol timing of the first cell.

In certain implementations, the NE 1100 may be configured to support a means for transmitting, in the second cell, a part of essential SI of the first cell. In such implementations, the NE 1100 may be configured to support a means for transmitting, in the first cell, a remaining essential SI of the first cell, upon detecting a random access preamble on a RACH occasion of the set of active RACH occasions of the first cell.

For assisted initial access to energy saving cells, the NE 1100 may be configured to support a means for transmitting, via a first cell, first SI including an indication of a neighboring cell in an energy saving state. In some implementations, the first SI includes a cell identity of the neighboring cell. In some implementations, the first SI includes a resource configuration for requesting the essential SI.

The NE 1100 may be configured to support a means for receiving a request signal via the neighboring cell. The NE 1100 may be configured to support a means for transmitting an on-demand SIB transmission via the neighboring cell, e.g., in response to the request signal, where the on-demand SIB transmission includes essential SI for the neighboring cell. In such implementations, the essential SI may include a MIB for the neighboring cell, or a SIB1 for the neighboring cell, or a combination thereof.

In some implementations, the NE 1100 may be further configured to transmit, via the neighboring cell, a broadcast including one or more synchronization signals. In certain implementations, the broadcast includes a first portion of the essential SI (e.g., the MIB) for the neighboring cell, and the on-demand SIB lacks the first portion of the essential SI (e.g., the MIB) for the neighboring cell. In other implementations, the first SI includes the first portion of the essential SI (e.g., the MIB) for the neighboring cell, the broadcast lacks the first portion of the essential SI (e.g., the MIB) for the neighboring cell, and the on-demand SIB lacks the first portion of the essential SI (e.g., the MIB) for the neighboring cell and includes a remainder of the essential SI (e.g., the SIB1).

In some implementations, the first SI indicates a set of parameters for the neighboring cell, the set of parameters including one or more of: i) a SFN of the neighboring cell; ii) an SFN offset with respect to a respective SFN of the first cell; iii) a subcarrier spacing for a common channel of the neighboring cell; iv) a PDCCH configuration for a common PDCCH of the neighboring cell; v) a frequency offset between a synchronization signal of the neighboring cell and an overall resource block grid of the neighboring cell; vi) a DM RS configuration for the neighboring cell; or a combination thereof. In certain implementations, the SFN of the neighboring cell may be based at least in part on a respective SFN of the first cell.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receiving the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the received signal and obtain the transmitted data by reversing the modulation technique applied during transmission of the signal. The receiver chain 1110 may include at least one decoder for decoding/processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

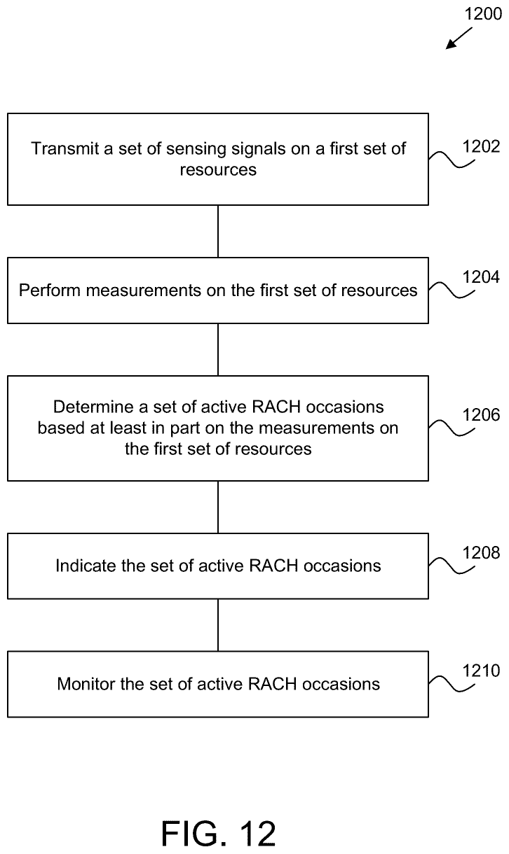

FIG. 12 depicts one embodiment of a method 1200 in accordance with aspects of the present disclosure. In various embodiments, the operations of the method 1200 may be implemented by a RAN as described herein. In some implementations, the RAN may execute a set of instructions to control the function elements of the RAN to perform the described functions.

At step 1202, the method 1200 may include transmitting a set of sensing signals on a first set of resources. The operations of step 1202 may be performed in accordance with examples as described herein. In some implementations, aspects of the operation of step 1202 may be performed by a NE, as described with reference to FIG. 11.

At step 1204, the method 1200 may include performing measurements on the first set of resources. The operations of step 1204 may be performed in accordance with examples as described herein. In some implementations, aspects of the operation of step 1204 may be performed by a NE, as described with reference to FIG. 11.

At step 1206, the method 1200 may include determining a set of active RACH occasions based at least in part on the measurements on the first set of resources. The operations of step 1206 may be performed in accordance with examples as described herein. In some implementations, aspects of the operation of step 1206 may be performed by a NE, as described with reference to FIG. 11.

At step 1208, the method 1200 may include indicating the set of active RACH occasions. The operations of step 1208 may be performed in accordance with examples as described herein. In some implementations, aspects of the operation of step 1208 may be performed by a NE, as described with reference to FIG. 11.

At step 1210, the method 1200 may include monitoring the set of active RACH occasions. The operations of step 1210 may be performed in accordance with examples as described herein. In some implementations, aspects of the operation of step 1210 may be performed by a NE, as described with reference to FIG. 11.

It should be noted that the method 1200 described herein describes one possible implementation, and that the operations and the steps may be rearranged or otherwise modified and that other implementations are possible.

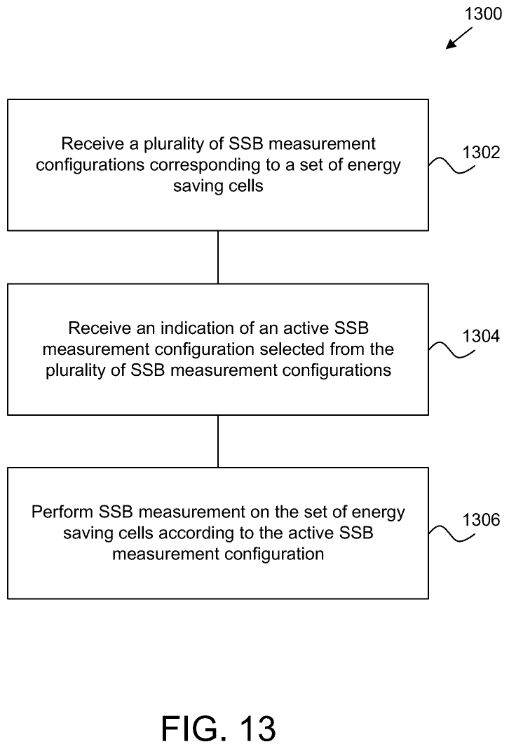

FIG. 13 depicts one embodiment of a method 1300 in accordance with aspects of the present disclosure. The operations of the method 1300 may be implemented by a UE as described herein. In some implementations, the UE may execute a set of instructions to control the function elements of the UE to perform the described functions.

At step 1302, the method 1300 may include receiving a plurality of SSB measurement configurations corresponding to a set of energy saving cells. The operations of step 1302 may be performed in accordance with examples as described herein. In some implementations, aspects of the operations of step 1302 may be performed by a UE, as described with reference to FIG. 9.

At step 1304, the method 1300 may include receiving an indication of an active SSB measurement configuration selected from the plurality of SSB measurement configurations. The operations of step 1304 may be performed in accordance with examples as described herein. In some implementations, aspects of the operations of step 1304 may be performed by a UE, as described with reference to FIG. 9.

At step 1306, the method 1300 may include performing SSB measurement on the set of energy saving cells according to the active SSB measurement configuration. The operations of step 1306 may be performed in accordance with examples as described herein. In some implementations, aspects of the operations of step 1306 may be performed by a UE, as described with reference to FIG. 9.

It should be noted that the method 1300 described herein describes one possible implementation, and that the operations and the steps may be rearranged or otherwise modified and that other implementations are possible.

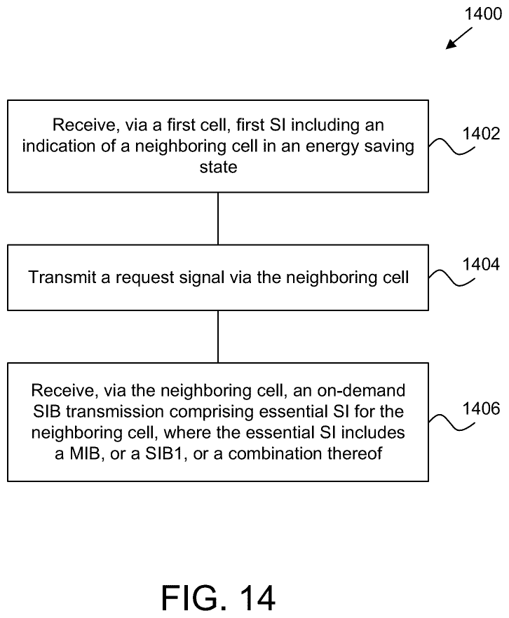

FIG. 14 depicts one embodiment of a method 1400 in accordance with aspects of the present disclosure. The operations of the method 1400 may be implemented by a UE as described herein. In some implementations, the UE may execute a set of instructions to control the function elements of the UE to perform the described functions.

At step 1402, the method 1400 may include receiving, via a first cell, first SI including an indication of a neighboring cell in an energy saving state. The operations of step 1402 may be performed in accordance with examples as described herein. In some implementations, aspects of the operations of step 1402 may be performed by a UE, as described with reference to FIG. 9.

At step 1404, the method 1400 may include transmitting a request signal to the neighboring cell. The operations of step 1404 may be performed in accordance with examples as described herein. In some implementations, aspects of the operations of step 1404 may be performed by a UE, as described with reference to FIG. 9.

At step 1406, the method 1400 may include receiving, from the neighboring cell, an on-demand SIB transmission including essential SI for the neighboring cell, where the essential SI includes a MIB for the neighboring cell, or a SIB1 for the neighboring cell, or a combination thereof. The operations of step 1406 may be performed in accordance with examples as described herein. In some implementations, aspects of the operations of step 1406 may be performed by a UE, as described with reference to FIG. 9.

It should be noted that the method 1400 described herein describes one possible implementation, and that the operations and the steps may be rearranged or otherwise modified and that other implementations are possible.

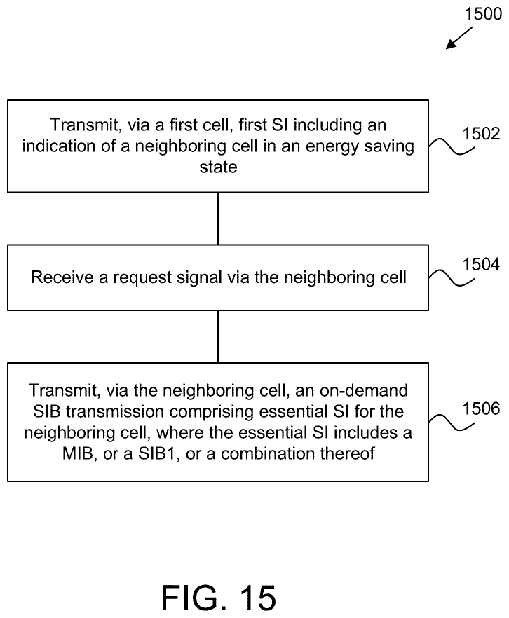

FIG. 15 depicts one embodiment of a method 1500 in accordance with aspects of the present disclosure. In various embodiments, the operations of the method 1500 may be implemented by a base station in a RAN, as described herein. In some implementations, the base station may execute a set of instructions to control the function elements of the base station to perform the described functions.

At step 1502, the method 1500 may include transmitting, via a first cell, first SI including an indication of a neighboring cell in an energy saving state. The operations of step 1502 may be performed in accordance with examples as described herein. In some implementations, aspects of the operation of step 1502 may be performed by a NE, as described with reference to FIG. 11.

At step 1504, the method 1500 may include receiving a request signal via the neighboring cell. The operations of step 1504 may be performed in accordance with examples as described herein. In some implementations, aspects of the operation of step 1504 may be performed by a NE, as described with reference to FIG. 11.

At step 1506, the method 1500 may include transmitting, via the neighboring cell, an on-demand SIB transmission including essential SI for the neighboring cell, wherein the essential SI includes a MIB for the neighboring cell, or a SIB1 for the neighboring cell, or a combination thereof. The operations of step 1506 may be performed in accordance with examples as described herein. In some implementations, aspects of the operation of step 1506 may be performed by a NE, as described with reference to FIG. 11.

It should be noted that the method 1500 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, via a first cell, first system information (SI) comprising an indication of a neighboring cell in an energy saving state;
transmit a request signal to the neighboring cell; and
receive, from the neighboring cell, an on-demand system information block (SIB) transmission comprising essential SI for the neighboring cell,
wherein the essential SI comprises a master information block (MIB) for the neighboring cell, or a SIB type 1 (SIB1) for the neighboring cell, or a combination thereof.

2. The UE of claim 1, wherein the first SI comprises a cell identity of the neighboring cell.

3. The UE of claim 1, wherein the first SI comprises a resource configuration for requesting the essential SI.

4. The UE of claim 1, wherein the at least one processor is further configured to cause the UE to receive a broadcast from the neighboring cell, wherein the broadcast comprises one or more synchronization signals.

5. The UE of claim 4, wherein the first SI comprises the MIB for the neighboring cell, wherein the broadcast lacks the MIB for the neighboring cell, and wherein the on-demand SIB lacks the MIB for the neighboring cell.

6. The UE of claim 4, wherein the broadcast comprises the MIB for the neighboring cell, and wherein the on-demand SIB lacks the MIB for the neighboring cell.

7. The UE of claim 1, wherein the first SI indicates a set of parameters for the neighboring cell, the set of parameters comprising one or more of:
a system frame number (SFN) of the neighboring cell;
an SFN offset with respect to a respective SFN of the first cell;
a subcarrier spacing for a common channel of the neighboring cell;
a physical downlink control channel (PDCCH) configuration for a common PDCCH of the neighboring cell;
a frequency offset between a synchronization signal of the neighboring cell and an overall resource block grid of the neighboring cell;
a demodulation reference signal (DM RS) configuration for the neighboring cell;
or a combination thereof.

8. The UE of claim 1, wherein the at least one processor is further configured to cause the UE to determine a system frame number (SFN) of the neighboring cell based at least in part on a respective SFN of the first cell.

9. The UE of claim 1, wherein the at least one processor is further configured to cause the UE to:
receive a broadcast from the neighboring cell, wherein the broadcast comprises one or more synchronization signals;
reselect from the first cell to the neighboring cell based at least in part on the broadcast; and
transmit the request signal in response to reselecting to the neighboring cell.

10. The UE of claim 9, wherein the broadcast comprises a first portion of the essential SI, and wherein the on-demand SIB comprises a remainder of the essential SI.

11. A processor for wireless communication, comprising:
at least one controller coupled with at least one memory and configured to cause the processor to:
receive, via a first cell, first system information (SI) comprising an indication of a neighboring cell in an energy saving state;
transmit a request signal to the neighboring cell; and
receive, from the neighboring cell, an on-demand system information block (SIB) transmission comprising essential SI for the neighboring cell,
wherein the essential SI comprises a master information block (MIB) for the neighboring cell, or a SIB type 1 (SIB1) for the neighboring cell, or a combination thereof.

12. A base station for wireless communication, comprising:
at least one memory; and
at least one processor coupled with the at least one memory and configured to cause the base station to:
transmit, via a first cell, first system information (SI) comprising an indication of a neighboring cell in an energy saving state;
receive a request signal via the neighboring cell; and
transmit, via the neighboring cell, an on-demand system information block (SIB) transmission comprising essential SI for the neighboring cell,
wherein the essential SI comprises a master information block (MIB) for the neighboring cell, or a SIB type 1 (SIB1) for the neighboring cell, or a combination thereof.

13. The base station of claim 12, wherein the first SI comprises a cell identity of the neighboring cell.

14. The base station of claim 12, wherein the first SI comprises a resource configuration for requesting the essential SI.

15. The base station of claim 12, wherein the at least one processor is further configured to cause the base station to transmit, via the neighboring cell, a broadcast comprising one or more synchronization signals.

16. The base station of claim 15, wherein the first SI comprises the MIB for the neighboring cell, wherein the broadcast lacks the MIB for the neighboring cell, and wherein the on-demand SIB lacks the MIB for the neighboring cell.

17. The base station of claim 15, wherein the broadcast comprises the MIB for the neighboring cell, and wherein the on-demand SIB lacks the MIB for the neighboring cell.

18. The base station of claim 12, wherein the first SI indicates a set of parameters for the neighboring cell, the set of parameters comprising one or more of:
a system frame number (SFN) of the neighboring cell;
an SFN offset with respect to a respective SFN of the first cell;
a subcarrier spacing for a common channel of the neighboring cell;
a physical downlink control channel (PDCCH) configuration for a common PDCCH of the neighboring cell;
a frequency offset between a synchronization signal of the neighboring cell and an overall resource block grid of the neighboring cell;
a demodulation reference signal (DM RS) configuration for the neighboring cell;
or a combination thereof.

19. The base station of claim 12, wherein a system frame number (SFN) of the neighboring cell is based at least in part on a respective SFN of the first cell.

20. A method performed by a base station, the method comprising:
transmitting, via a first cell, first system information (SI) comprising an indication of a neighboring cell in an energy saving state;
receiving a request signal via the neighboring cell; and
transmitting, via the neighboring cell, an on-demand system information block (SIB) transmission comprising essential SI for the neighboring cell,
wherein the essential SI comprises a master information block (MIB) for the neighboring cell, or a SIB type 1 (SIB1) for the neighboring cell, or a combination thereof.
